(19) United States
(12) Patent Application Publication
(10) Pub. No.: US 2018/0260042 A1
(43) Pub. Date: Sep. 13, 2018

(54) Inside-Out 6DoF Systems, Methods And Apparatus

(71) Applicant: MediaTek Inc., Hsinchu City (TW)

(72) Inventors: Kui-Chang Tseng, Hsinchu City (TW); Tsu-Ming Liu, Hsinchu City (TW)

(21) Appl. No.: 15/915,058

(22) Filed: Mar. 7, 2018

Related U.S. Application Data
(60) Provisional application No. 62/469,036, filed on Mar. 9, 2017.

(51) Int. Cl. G06F 3/0346; G06F 3/042; G06F 3/038; G01P 15/14; G01C 21/16

(52) U.S. Cl. CPC G06F 3/0346; G06F 3/0425; G01C 21/165; G01P 15/14; G06F 3/038

(57) ABSTRACT

A processor of an apparatus receives sensor data from an inertial measurement unit (IMU). The processor also receives image data. The processor performs a fusion process on the sensor data and the image data to provide a translation output. The processor then performs one or more six-degrees-of-freedom (6DoF)-related operations using the translation output.

### CROSS REFERENCE TO RELATED PATENT APPLICATION

The present disclosure claims the priority benefit of U.S. Provisional Patent Application No. 62/469,036, filed on 9 Mar. 2017. Content of the aforementioned application is incorporated by reference in its entirety.

### TECHNICAL FIELD

The present disclosure is generally related to detection of movement and selection in images. In particular, the present disclosure is related to a six-degrees-of-freedom (6 DoF) system.

### BACKGROUND

Unless otherwise indicated herein, approaches described in this section are not prior art to the claims listed below and are not admitted as prior art by inclusion in this section.

Six degrees of freedom refers to the freedom of movement in a three-dimensional (3D) space. Specifically, the movement in the 3D space can include changes in position as forward/backward, up/down and left/right translational movements in three perpendicular axes combined with changes in orientation through rotations about the three perpendicular axes denoted as yaw, pitch and roll. Applications of 6 DoF systems include, for example, robotics, engineering, industrial use, gaming, virtual reality (VR) and augmented reality (AR). Conventional 6 DoF systems, however, tend to require multiple cameras in additional to an inertial measurement unit (IMU) to detect the position, orientation and movement (e.g., velocity and acceleration) of an object or user. Moreover, accuracy of the detection is sometimes less than ideal.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

The present disclosure provides schemes, techniques, methods and systems pertaining to cost-effective 6 DoF. For instance, under a proposed scheme, a cost-effective 6 DoF system may utilize an IMU and a single camera to detect and measurement motions and movements of an object or a user and utilize results of the detection/measurement to perform 6 DoF-related operations. In some cases, centrifugal force from an angular velocity as measured by a gyroscope in the IMU may be compensated. Similarly, a radius from the camera may be compensated. The data from the camera and IMU may be fused to provide a translation output for 6 DoF-related operations, where the translation output has low latency and high report rate with scale.

In one aspect, a method may involve a processor of an apparatus receiving sensor data from an IMU. The method may involve the processor receiving image data from a camera. The method may also involve the processor performing a fusion process on the sensor data and the image data to provide a translation output. The method may additionally involve the processor performing one or more 6 DoF-related operations using the translation output.

In one aspect, an apparatus may include a camera, an IMU and a processor communicatively coupled to the camera and the IMU. The camera may be capable of capturing images to provide image data. The IMU may be capable of measuring motion-related parameters to provide sensor data. The processor may be capable of receiving the sensor data from the IMU as well as receiving the image data from the camera. The processor may also be capable of performing a fusion process on the sensor data and the image data to provide a translation output. The processor may be further capable of performing one or more 6 DoF-related operations using the translation output.

### BRIEF DESCRIPTION OF THE DRAWINGS

The accompanying drawings are included to provide a further understanding of the present disclosure and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example operational flow in accordance with an implementation of the present disclosure.

FIG. 3 is a diagram of an example operational flow in accordance with an implementation of the present disclosure.

FIG. 4 is a diagram of an example scenario in accordance with an implementation of the present disclosure.

FIG. 5 is a diagram of an example apparatus in accordance with an implementation of the present disclosure.

FIG. 6 is a flowchart of a process in accordance with an implementation of the present disclosure.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### Overview

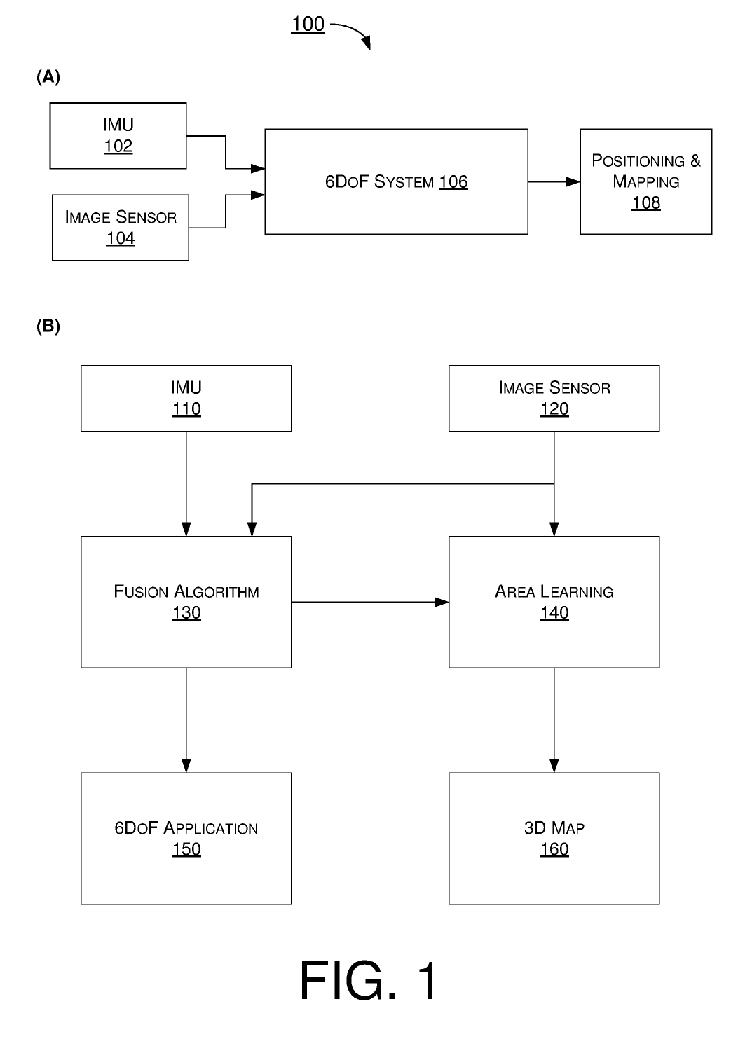

FIG. 1 illustrates an example scenario 100 in accordance with an implementation of the present disclosure. Scenario 100 may pertain to cost-effective 6 DoF in accordance with the present disclosure. Scenario 100 may be implemented on a HMD, a wearable device or any suitable device.

Referring to part (A) of FIG. 1, scenario 100 may be implemented using an apparatus having an IMU 102, an image sensor 104 (e.g., camera) and a 6 DoF system 106, which fuses sensor data from IMU 102 and image data from image sensor 104, to provide an output or perform operations related to positioning and mapping 108. As described below with respect to apparatus 500, the 6 DoF system 106 may be implemented in a processor such as an integrated-circuit (IC) chip.

Referring to part (B) of FIG. 1, scenario 100 may be implemented using an apparatus having an IMU 110, an image sensor 120 (e.g., camera), a fusion algorithm function 130 and an area learning function 140. Specifically, fusion algorithm function 130 may utilize sensor data from IMU 110 and image data from image sensor 120 to provide a translation output, which may be utilized by a 6 DoF application 105 to perform one or more 6 DoF-related operations. Moreover, area learning function 140 may utilize the translation output, the sensor data and the image data to generate a 3D map 160.

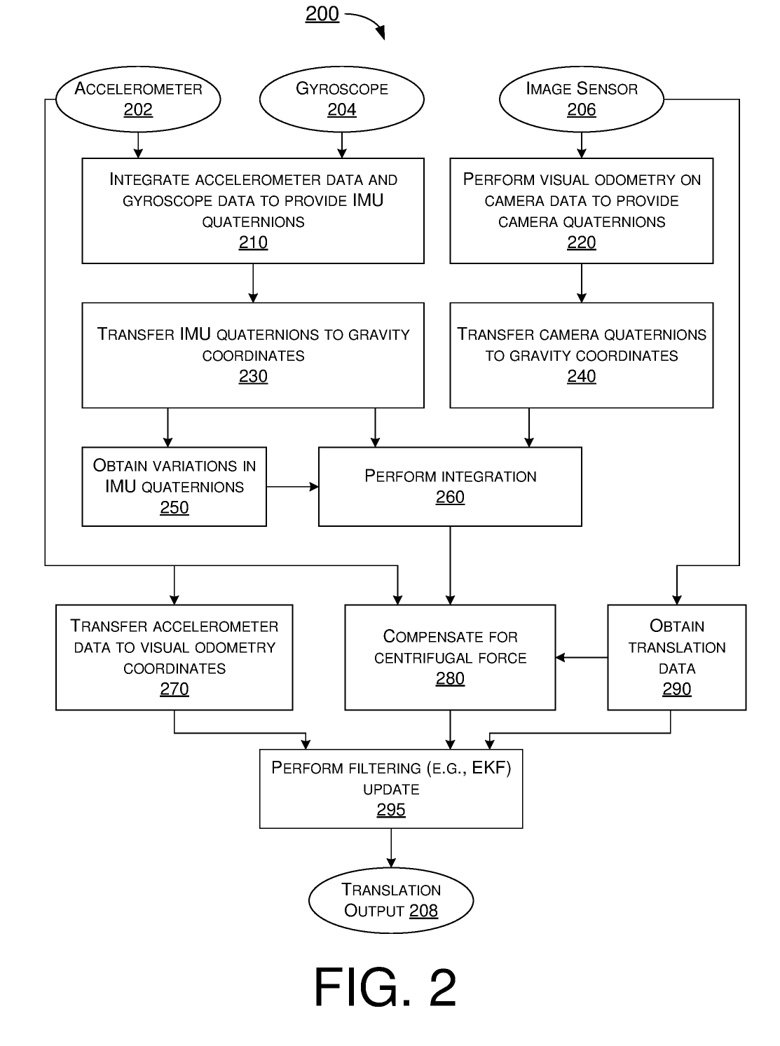

FIG. 2 illustrates an example operational flow 200 in accordance with an implementation of the present disclosure. Operational flow 200 may represent an aspect of implementing the proposed concepts and schemes with respect to cost-effective 6 DoF. Operational flow 200, whether partially or completely, may be implemented in scenario 100 described above and/or scenario 400 described below. Operational flow 200 may include one or more operations, actions, or functions as illustrated by one or more of blocks 210, 220, 230, 240, 250, 260, 270, 280, 290 and 295. Although illustrated as discrete blocks, various blocks of operational flow 200 may be divided into additional blocks, combined into fewer blocks, or eliminated, depending on the desired implementation. Moreover, the blocks of operational flow 200 may be executed in the order shown in FIG. 2 or, alternatively, in a different order. Operational flow 200 may also include additional operations not shown in FIG. 2. One or more of the blocks of operational flow 200 may be executed iteratively. Operational flow 200 may begin at blocks 210 and/or 220.

At 210, operational flow 200 may involve integrating accelerometer data from an accelerometer 202 and gyroscope data from a gyroscope 204 to provide IMU quaternions. Operational flow 200 may proceed from 210 to 230.

At 220, operational flow 200 may involve performing visual inertial odometry on image data from an image sensor 206 (e.g., camera) to provide camera quaternions. Operational flow 200 may proceed from 220 to 240.

At 230, operational flow 200 may involve transferring IMU quaternions to first gravity coordinates. Operational flow 200 may proceed from 230 to 250 and 260.

At 240, operational flow 200 may involve transferring camera quaternions to second gravity coordinates. Operational flow 200 may proceed from 240 to 260.

At 250, operational flow 200 may involve obtaining variations in IMU quaternions. Operational flow 200 may proceed from 250 to 260.

At 260, operational flow 200 may involve performing integration on the first gravity coordinates, second gravity coordinates and variations in IMU quaternions to provide a quaternion output. Operational flow 200 may proceed from 260 to 280.

At 270, operational flow 200 may involve transferring the accelerometer data from accelerometer 202 to visual odometry coordinates. Operational flow 270 may proceed from 270 to 295.

At 280, operational flow 200 may involve compensating for a centrifugal force in an angular rate, as measured by accelerometer 202, with respect to the quaternion output to provide a compensated output. Operational flow 200 may proceed from 280 to 295.

At 290, operational flow 200 may involve obtaining translation data using the image data from image sensor 206. Operational flow 200 may proceed from 290 to 295.

At 295, operational flow 200 may involve performing a filtering process (e.g., by using an Extended Kalman filter (EFK)) on the accelerometer data in the visual odometry coordinates, the compensated output, and the translation data to provide a translation output 208.

For illustrative purposed, and without limiting the scope of the present disclosure, compensation for the centrifugal force may be mathematically denoted by Equation 1 below.

$$\begin{matrix}α = \frac{{d}^{ 2} r}{{dt}^{ 2}} = \frac{d}{dt} \frac{dr}{dt} = \frac{d}{dt} ( [ \frac{dr}{dt} ] + ω \times r ) \\ = [ \frac{{d}^{ 2} r}{{dt}^{ 2}} ] + ω \times [ \frac{dr}{dt} ] + \frac{d ω}{dt} \times r + ω \times \frac{dr}{dt} \\ = [ \frac{{d}^{ 2} r}{{dt}^{ 2}} ] + ω \times [ \frac{dr}{dt} ] + \frac{d ω}{dt} \times r + ω \times ( [ \frac{dr}{dt} ] + ω \times r ) \\ = [ \frac{{d}^{ 2} r}{{dt}^{ 2}} ] + \frac{d ω}{dt} \times r + 2 ω \times [ \frac{dr}{dt} ] + ω \times ( ω \times r ) .\end{matrix} \qquad ( 1 )$$

In Equation 1, the term α represents one of three dimensions of x, y, z in the three perpendicular axes for translational movements in the 3D space. That is, for the x-axis, α in Equation 1 may be denoted by αₓ; for the y-axis, α in Equation 1 may be denoted by αₓ; and for the z-axis, α in Equation 1 may be denoted by α_{z}. The terms γ,

$$[ \frac{dr}{dt} ] , [ \frac{{d}^{ 2} r}{{dt}^{ 2}} ]$$

may be obtained from translation output, and the term Ω may be obtained from quaternions.

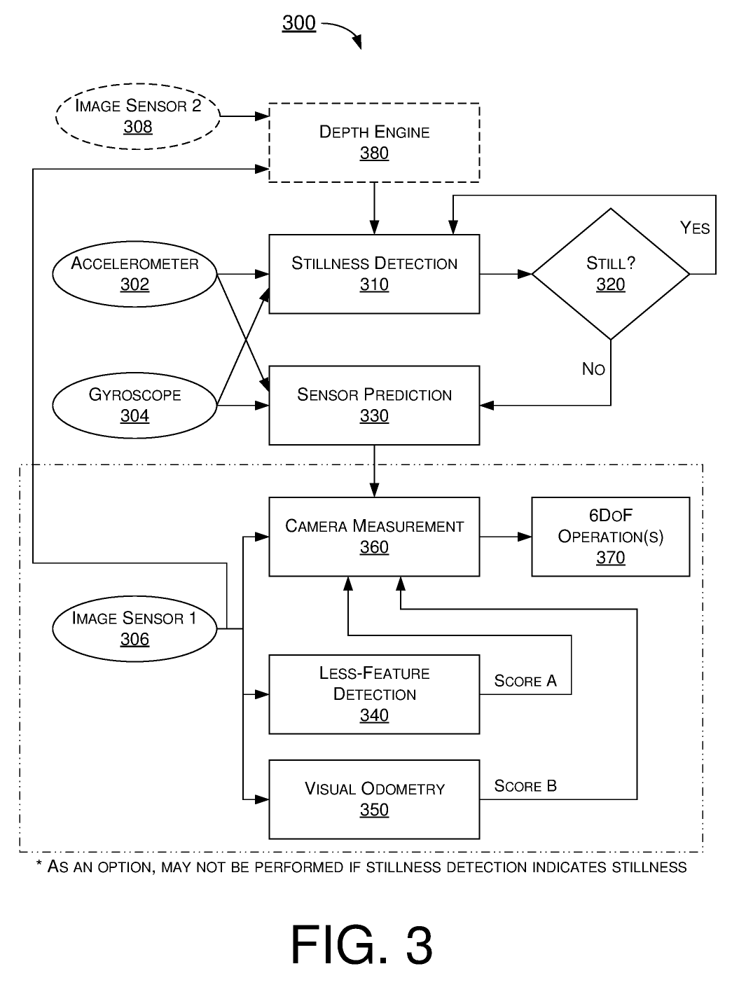

FIG. 3 illustrates an example operational flow 300 in accordance with an implementation of the present disclosure. Operational flow 300 may represent an aspect of implementing the proposed concepts and schemes with respect to cost-effective 6 DoF. Operational flow 300, whether partially or completely, may be implemented in scenario 100 described above and/or scenario 400 described below. Operational flow 300 may include one or more operations, actions, or functions as illustrated by one or more of blocks 310, 320, 330, 340, 350, 360, 370 and, optionally, 380. Although illustrated as discrete blocks, various blocks of operational flow 300 may be divided into additional blocks, combined into fewer blocks, or eliminated, depending on the desired implementation. Moreover, the blocks of operational flow 300 may be executed in the order shown in FIG. 3 or, alternatively, in a different order. Operational flow 300 may also include additional operations not shown in FIG. 3. One or more of the blocks of operational flow 300 may be executed iteratively. Operational flow 300 may begin at blocks 310, 340 and/or 350.

At 310, operational flow 300 may involve performing stillness detection using accelerometer data from an accelerometer 302 and gyroscope data from a gyroscope 304. Operational flow 300 may proceed from 310 to 320.

At 320, operational flow 300 may involve determining whether stillness (e.g., no motion) is detected. In an event that stillness is not detected (e.g., moving object or moving user being detected), operational flow 300 may proceed from 320 to 330. In an event that stillness is detected, operational flow 300 may proceed from 320 to 310 to continue stillness detection.

At 330, operational flow 300 may involve performing sensor prediction using accelerometer data from accelerometer 302 and gyroscope data from gyroscope 304 to provide a prediction result. Operational flow 300 may proceed from 330 to 360.

At 340, operational flow 300 may involve performing less-feature detection on image data from an image sensor 306 (e.g., a first camera, denoted as “Image Sensor 1” in FIG. 3) to provide a first score (denoted as “Score A” in FIG. 3) as a first fusion factor. Operational flow 300 may proceed from 340 to 360.

At 350, operational flow 300 may involve performing visual inertial odometry on the image data to provide a second score (denoted as “Score B” in FIG. 3) as a second fusion factor. Operational flow 300 may proceed from 350 to 360.

At 360, operational flow 300 may involve performing camera measurement to provide a translation output using the prediction result, the image data, the first fusion factor, and the second fusion factor. Operational flow 300 may proceed from 360 to 370.

At 370, operational flow 300 may involve performing one or more 6 DoF operations using the translation output.

In some cases, when there is at least one additional image sensor 308 (e.g., a second camera, denoted as “Image Sensor 2” in FIG. 3), operational flow 300 may involve executing a depth engine 380 with image data from image sensor 306 and image data from image sensor 308 to perform depth detection to provide a depth detection result, which may be used as an additional input for stillness detection at 310.

As indicated above, in an event that stillness is detected, operational flow 300 may proceed from 320 back to 310. In other words, when stillness is detected, there is no need to perform operations represented by blocks 340, 350, 360 and 370. Accordingly, in some implementations, in an event that stillness is detected, operational flow 300 may cease performing operations represented by 340, 350, 360 and 370, thereby reducing power consumption for improved power conservation.

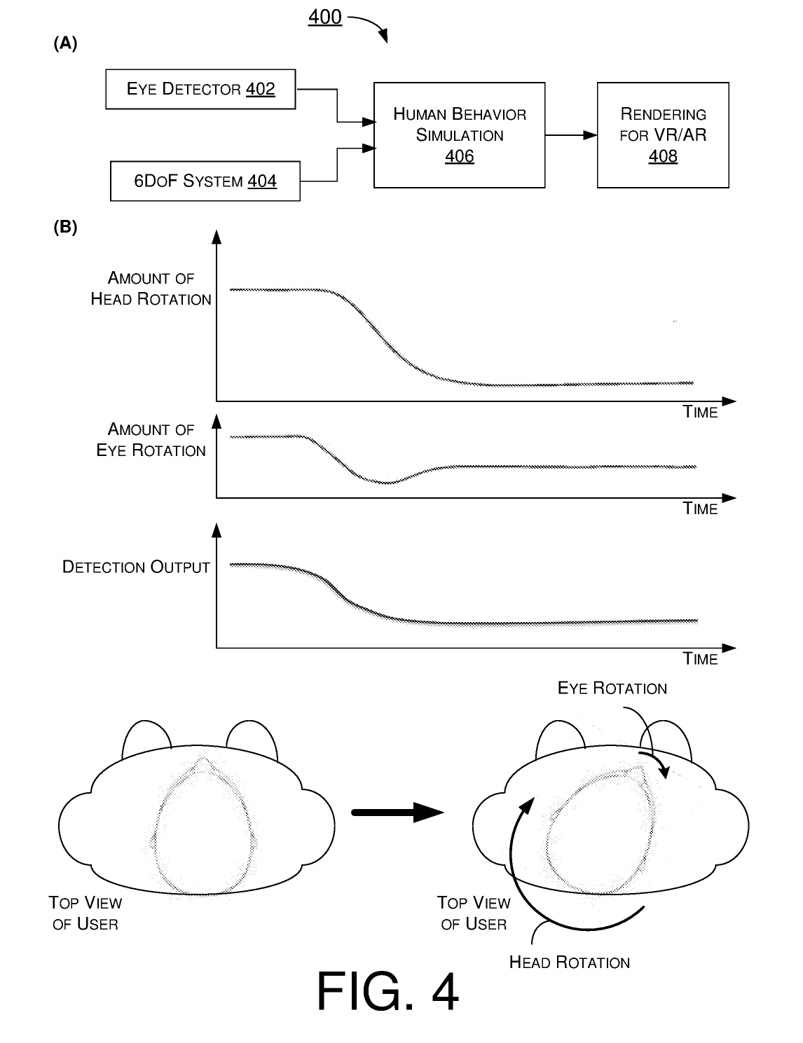

FIG. 4 illustrates an example scenario 400 in accordance with an implementation of the present disclosure. Scenario 400 may pertain to cost-effective 6 DoF in accordance with the present disclosure. Scenario 400 may be implemented on a HMD, a wearable device or any suitable device.

Referring to part (A) of FIG. 4, scenario 400 may be implemented using an apparatus having an eye detector 402, a 6 DoF system 404 and a human behavior simulation module 406, which utilizes eye movement data from eye detector 402 and a translation output from the 6 DoF system 404, to render 3D graphics and/or images for VR and/or AR 408. As described below with respect to apparatus 500, the 6 DoF system 404 may be implemented in a processor such as an IC chip. The 6 DoF system 404 may be used in a display control system such as, for example, a VR rendering system. The human behavior simulation module 406 may perform latency control on an output of the 6 DoF system 404 (e.g., by utilizing the eye movement data). The latency control may result in latency in a detection output to be like natural human behavior.

Referring to part (B) of FIG. 4, in scenario 400, an amount of head rotation as detected or otherwise measured by the 6 DoF system 404 and an amount of eye rotation as detected or otherwise measured by the eye detector 402 may be fused together with compensation for centrifugal force to provide a detection output. That is, the detection output may include a latency that is similar to natural human behavior (e.g., when turning head and eyes to look to aside).

### Illustrative Implementations

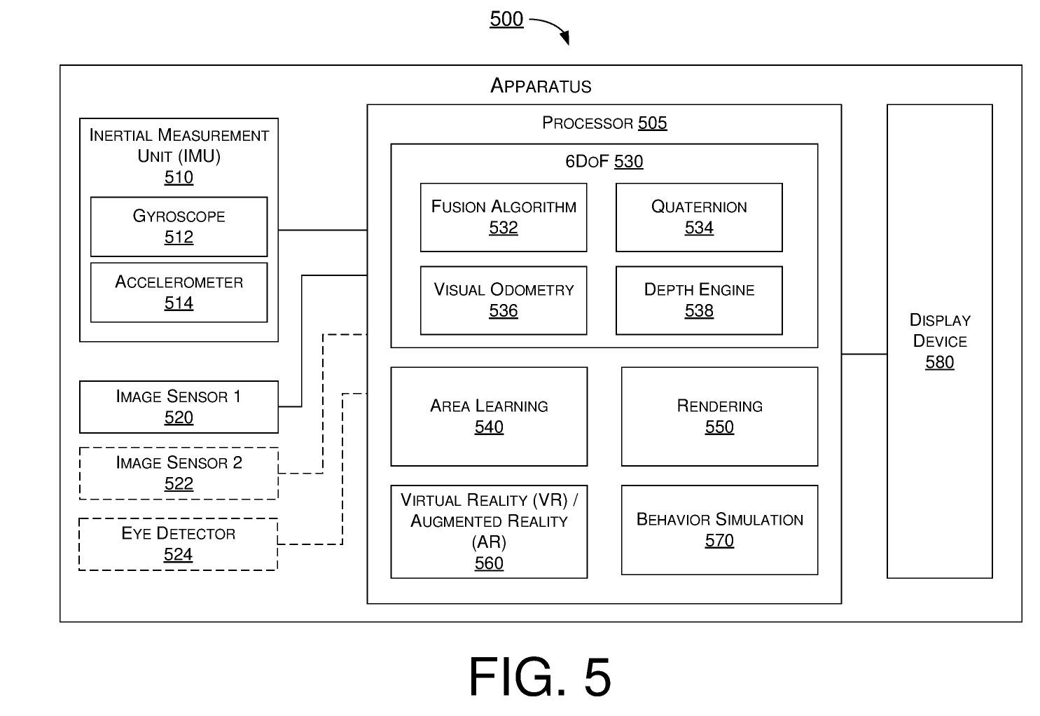

FIG. 5 illustrates an example apparatus 500 in accordance with an implementation of the present disclosure. Apparatus 500 may perform various functions to implement schemes, techniques, processes and methods described herein pertaining to cost-effective 6 DoF, including those with respect to scenario 100, operational flow 200, operational flow 300 and scenario 400 described above as well as process 600 described below.

Apparatus 500 may be a part of an electronic apparatus, which may be an intelligent display apparatus, a portable or mobile apparatus, a wearable apparatus, a wireless communication apparatus or a computing apparatus. For instance, apparatus 500 may be implemented in a head gear or head-mounted display (HMD) for VR and/or AR, a smartphone, a smartwatch, a personal digital assistant, a digital camera, or a computing equipment such as a tablet computer, a laptop computer or a notebook computer. Alternatively, apparatus 500 may be implemented in the form of one or more integrated-circuit (IC) chips such as, for example and without limitation, one or more single-core processors, one or more multi-core processors, or one or more complex-instruction-set-computing (CISC) processors. Apparatus 500 may include at least some of those components shown in FIG. 5 such as a processor 505, for example. Apparatus 500 may further include one or more other components not pertinent to the proposed scheme of the present disclosure (e.g., internal power supply, memory/data storage, communication device, and power management), and, thus, such component(s) of apparatus 500 are neither shown in FIG. 5 nor described below in the interest of simplicity and brevity.

In one aspect, processor 505 may be implemented in the form of one or more single-core processors, one or more multi-core processors, or one or more CISC processors. That is, even though a singular term “a processor” is used herein to refer to processor 505, processor 505 may include multiple processors in some implementations and a single processor in other implementations in accordance with the present disclosure. In another aspect, processor 505 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 505 is a special-purpose machine specifically designed, arranged and configured to perform specific tasks including cost-effective 6 DoF in accordance with various implementations of the present disclosure. In some implementations, processor 505 may include a 6 DoF module 530 capable of performing operations pertaining to cost-effective 6 DoF in accordance with the present disclosure. Optionally, processor 505 may also include an area learning module 540, a rendering module 550, a VR/AR module 560 and/or a behavior simulation module 570. In some implementations, each of 6 DoF module 530, area learning module 540, rendering module 550, VR/AR module 560 and behavior simulation module 570 may be implemented in hardware such as electronic circuits. Alternatively, each of 6 DoF module 530, area learning module 540, rendering module 550, VR/AR module 560 and behavior simulation module 570 may be implemented in software. Still alternatively, each of 6 DoF module 530, area learning module 540, rendering module 550, VR/AR module 560 and behavior simulation module 570 may be implemented in both hardware and software. In some implementations, the 6 DoF module 530 may include at least a fusion algorithm module 532, a quaternion module 534, a visual odometry module 536 and a depth engine 538.

In some implementations, apparatus 500 may include an IMU 510 and at least a first image sensor 520 (e.g., a first camera, denoted as “Image Sensor 1” in FIG. 5). Optionally, apparatus 500 also include a second image sensor 522 (e.g., a second camera, denoted as “Image Sensor 2” in FIG. 5) and/or an eye detector 524. In some implementations, apparatus 500 may also include a display device that is controlled by processor 505 and capable of displaying videos and still images such as, for example and without limitation, 3D images and videos for VR and/or AR. IMU 510 may include at least a gyroscope 512 and an accelerometer 514 that are capable of measuring various motion-related parameters such as a force, acceleration, velocity, angular rate and the like. That is, gyroscope 512 may generate gyroscope data as a result of measuring and accelerometer 514 may generate accelerometer data as a result of the measuring. Moreover, IMU 512 may generate sensor data to report results of the measuring. Each of first image sensor 520 and second image sensor 522 may be capable of capturing images (e.g., still images and/or video images) and generate image data as a result of image capture. Eye detector 524 may be capable of detecting and tracking a movement of a user's eyeball and generate eye movement data as a result of the detecting and tracking.

In some implementations, processor 505 may receive sensor data from 510 and image data from first image sensor 520. The fusion algorithm module 532 of the 6 DoF module 530 of processor 505 may perform a fusion process on the sensor data and the image data to provide a translation output. Moreover, processor 505 may perform one or more 6 DoF-related operations using the translation output. Additionally, area learning module 540 of processor 505 may utilize the translation output and image data to generate a 3D map of the surrounding area. Furthermore, rendering module 550 of processor 505 may utilize the translation output to render 3D graphics and/or 3D images for display by display device 580.

In some implementations, in performing the fusion process on the sensor data and the image data, the 6 DoF module 530 may fuse the sensor data and the image data to generate a result with scale such that the result has a latency lower than a threshold latency and a report rate higher than a threshold report rate.

In some implementations, in performing the fusion process on the sensor data and the image data, the 6 DoF module 530 may perform a number of operations. For instance, the 6 DoF module 530 may calculate a scale of a movement based on double integration of the accelerometer data. The 6 DoF module 530 may also obtain aligned quaternion coordinates. The 6 DoF module 530 may further compensate for a centrifugal force with respect to an angular velocity in the gyroscope data and a radius in the image data.

In some implementations, in obtaining the aligned quaternion coordinates, the 6 DoF module 530 may perform a number of operations. For instance, the quaternion module 534 of the 6 DoF module 530 may integrate the gyroscope data and the accelerometer data to provide IMU quaternions. Additionally, the quaternion module 534 of the 6 DoF module 530 may transfer the IMU quaternions to first gravity coordinates. Also, the visual odometry module 536 of the 6 DoF module 530 may perform visual inertial odometry on the image data to provide camera quaternions. Moreover, the quaternion module 534 of the 6 DoF module 530 may transfer the camera quaternions to second gravity coordinates. Furthermore, the quaternion module 534 of the 6 DoF module 530 may integrate the first gravity coordinates, the second gravity coordinates and variations in the IMU quaternions to provide the aligned quaternion coordinates.

In some implementations, in compensating for the centrifugal force with respect to the angular velocity in the gyroscope data and the radius in the image data, the 6 DoF module 530 may obtain translation data on an amount of translational movement based on the visual inertial odometry without compensating. Accordingly, the 6 DoF module 530 may compensate for the centrifugal force using the accelerometer data, the aligned quaternion coordinates, and the translation data to provide a compensated output.

In some implementations, the 6 DoF module 530 may transfer the accelerometer data to visual odometry coordinates. Moreover, the 6 DoF module 530 may perform a filtering process on the accelerometer data in the visual odometry coordinates, the compensated output, and the translation data to provide a translation output. For instance, the 6 DoF module 530 may perform the filtering process using an Extended Kalman filter (EKF).

In some implementations, in performing the fusion process on the sensor data and the image data, the 6 DoF module may perform a number of operations. For instance, the 6 DoF module may perform stillness detection based on the accelerometer data and the gyroscope data. In response to the stillness detection indicating a motion, the 6 DoF module 530 may perform sensor prediction to provide a prediction result. Additionally, the 6 DoF module 530 may perform less-feature detection on the image data to provide a first fusion factor. Moreover, visual odometry module 536 of the 6 DoF module 530 may perform visual inertial odometry on the image data to provide a second fusion factor. Furthermore, the 6 DoF module 530 may perform camera measurement to provide an output using the prediction result, the image data, the first fusion factor, and the second fusion factor.

In some implementations, apparatus 500 may include second image sensor 522 and thus processor 505 may receive additional image data from second image sensor 522. Accordingly, in performing the stillness detection, the depth engine 538 of the 6 DoF module 530 may perform depth detection using the image data from first image sensor 520 and the additional image data from second image sensor 522 to provide a depth detection result. Moreover, the 6 DoF module 530 may perform the stillness detection based on the accelerometer data, the gyroscope data, and the depth detection result.

In some implementations, apparatus 500 may include eye detector 524 and thus processor 505 may receive eye movement data from eye detector 524. Accordingly, in performing the one or more 6 DoF-related operations using the translation output, the behavior simulation module 570 of processor 505 may perform behavior simulation using the eye movement data and the 6 DoF output to provide a simulated human behavior with a latency in movement. Moreover, the VR/AR module 560 may render VR or AR using the simulated human behavior.

### Illustrative Processes

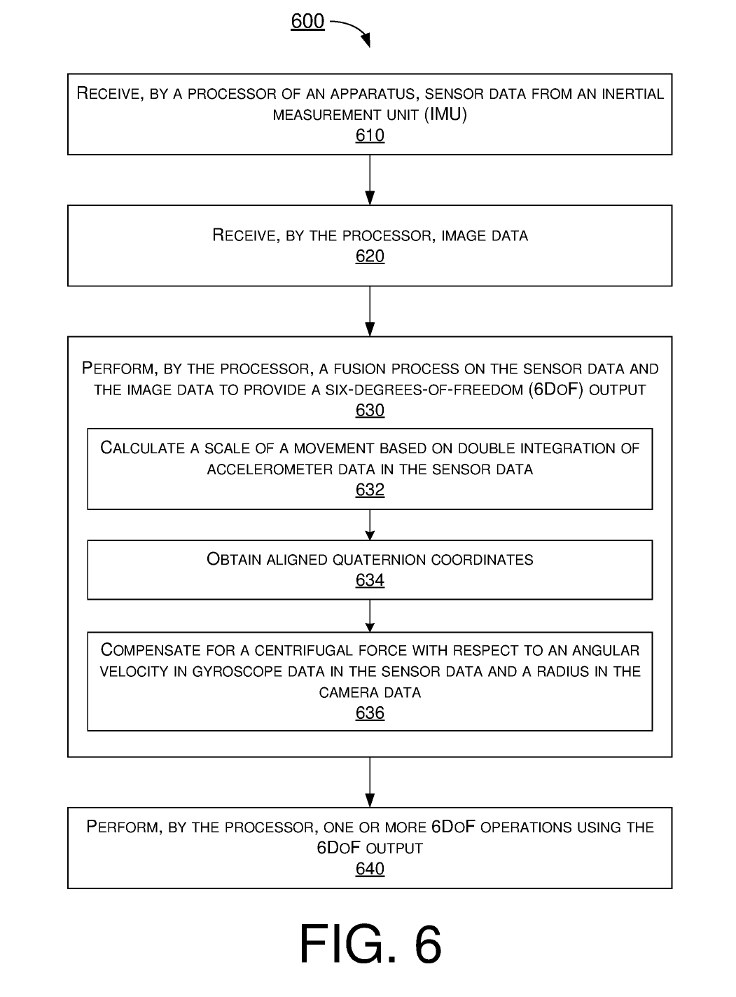

FIG. 6 illustrates an example process 600 in accordance with an implementation of the present disclosure. Process 600 may represent an aspect of implementing the proposed concepts and schemes such as one or more of the various schemes, concepts, embodiments and examples described above with respect to FIG. 1˜FIG. 4. More specifically, process 600 may represent an aspect of the proposed concepts and schemes pertaining to a cost-effective 6 DoF system. Process 600 may include one or more operations, actions, or functions as illustrated by one or more of blocks 610, 620, 630 and 640 as well as sub-blocks 632, 634 and 636. Although illustrated as discrete blocks, various blocks of process 600 may be divided into additional blocks, combined into fewer blocks, or eliminated, depending on the desired implementation. Process 600 may also include additional operations and/or acts not shown in FIG. 6. Moreover, the blocks of process 600 may be executed in the order shown in FIG. 6 or, alternatively, in a different order. The blocks of process 600 may also be executed iteratively. Process 600 may be implemented by or in apparatus 500 as well as any variations thereof. Solely for illustrative purposes and without limiting the scope, process 600 is described below with reference to apparatus 500. Process 600 may begin at block 610.

At 610, process 600 may involve processor 505 of apparatus 500 receiving sensor data from IMU 510. Process 600 may proceed from 610 to 620.

At 620, process 600 may involve processor 505 receiving image data (e.g., from first image sensor 520). Process 600 may proceed from 620 to 630.

At 630, process 600 may involve processor 505 performing a fusion process on the sensor data and the image data to provide a translation output. Specifically, process 600 may involve processor 505 performing a number of operations as represented by sub-blocks 632˜636.

At 632, process 600 may involve processor 505 calculating a scale of a movement based on double integration of accelerometer data in the sensor data (from accelerometer 514). Process 600 may proceed from 632 to 634.

At 634, process 600 may involve processor 505 obtaining aligned quaternion coordinates. Process 600 may proceed from 634 to 636.

At 636, process 600 may involve processor 505 compensating for a centrifugal force with respect to an angular velocity in gyroscope data in the sensor data (from gyroscope 512) and a radius in the image data. Process 600 may proceed from 630 to 640.

At 640, process 600 may involve processor 505 performing one or more 6 DoF-related operations using the translation output. For instance, process 600 may involve processor 505 rendering 3D images using the fusion output and controlling display device 580 to display the 3D images for VR or AR. Alternatively, process 600 may involve processor 505 controlling a robotic machinery to perform operations using the fusion output.

In some implementations performing the fusion process on the sensor data and the image data, process 600 may involve processor 505 compensating for a centrifugal force with respect to an angular velocity in the sensor data and a radius in the image data. Alternatively, or additionally, in performing the fusion process on the sensor data and the image data, process 600 may involve processor 505 fusing the sensor data and the image data to generate a result with scale. Advantageously, the result may have a latency lower than a threshold latency and a report rate higher than a threshold report rate.

In some implementations, in obtaining the aligned quaternion coordinates, process 600 may involve processor 505 performing a number of operations. For instance, process 600 may involve processor 505 integrating the gyroscope data and the accelerometer data to provide IMU quaternions. Additionally, process 600 may involve processor 505 transferring the IMU quaternions to first gravity coordinates. Moreover, process 600 may involve processor 505 performing visual inertial odometry on the image data to provide camera quaternions. Furthermore, process 600 may involve processor 505 transferring the camera quaternions to second gravity coordinates. Also, process 600 may involve processor 505 integrating the first gravity coordinates, the second gravity coordinates and variations in the IMU quaternions to provide the aligned quaternion coordinates.

In some implementations, in compensating for the centrifugal force with respect to the angular velocity in the gyroscope data and the radius in the image data, process 600 may involve processor 505 obtaining translation data on an amount of translational movement based on the visual inertial odometry without compensating. Additionally, process 600 may involve processor 505 compensating for the centrifugal force using the accelerometer data, the aligned quaternion coordinates, and the translation data to provide a compensated output.

In some implementations, process 600 may also involve processor 505 transferring the accelerometer data to visual odometry coordinates. Moreover, process 600 may involve processor 505 performing a filtering process on the accelerometer data in the visual odometry coordinates, the compensated output, and the translation data to provide a translation output. In some implementations, in performing the filtering process, process 600 may involve processor 505 performing the filtering process using an EKF.

In some implementations, in performing the fusion process on the sensor data and the image data, process 600 may involve processor 505 performing stillness detection based on the accelerometer data and the gyroscope data. In response to the stillness detection indicating a motion, process 600 may involve processor 505 performing a number of operations. For instance, process 600 may involve processor 505 performing sensor prediction to provide a prediction result. Additionally, process 600 may involve processor 505 performing less-feature detection on the image data to provide a first fusion factor. Moreover, process 600 may involve processor 505 performing visual inertial odometry on the image data to provide a second fusion factor. Furthermore, process 600 may involve processor 505 performing camera measurement to provide an output using the prediction result, the image data, the first fusion factor, and the second fusion factor.

In some implementations, in performing the stillness detection, process 600 may involve processor 505 performing a number of operations. For instance, process 600 may involve processor 505 receiving additional image data from an additional camera. Moreover, process 600 may involve processor 505 performing depth detection using the image data and the additional image data to provide a depth detection result. Additionally, process 600 may involve processor 505 performing the stillness detection based on the accelerometer data, the gyroscope data, and the depth detection result.

In some implementations, in performing the one or more 6 DoF-related operations using the translation output, process 600 may involve processor 505 performing a number of operations. For instance, process 600 may involve processor 505 receiving eye movement data from an eye detector. Additionally, process 600 may involve processor 505 performing behavior simulation using the eye movement data and the 6 DoF output to provide a simulated human behavior with a latency in movement. Furthermore, process 600 may involve processor 505 rendering virtual reality (VR) or augmented reality (AR) using the simulated human behavior.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, sensor data from an inertial measurement unit (IMU);
receiving, by the processor, image data;
performing, by the processor, a fusion process on the sensor data and the image data to provide a translation output; and
performing, by the processor, one or more six-degrees-of-freedom (6 DoF)-related operations using the translation output.

2. The method of claim 1, wherein the performing of the fusion process on the sensor data and the image data comprises compensating for a centrifugal force with respect to an angular velocity in the sensor data and a radius in the image data.

3. The method of claim 1, wherein the sensor data comprises accelerometer data from an accelerometer of the IMU and gyroscope data from a gyroscope of the IMU, and wherein the performing of the fusion process on the sensor data and the image data comprises:
calculating a scale of a movement based on double integration of the accelerometer data;
obtaining aligned quaternion coordinates; and
compensating for a centrifugal force with respect to an angular velocity in the gyroscope data and a radius in the image data.

4. The method of claim 3, wherein the obtaining of the aligned quaternion coordinates comprises:
integrating the gyroscope data and the accelerometer data to provide IMU quaternions;
transferring the IMU quaternions to first gravity coordinates;
performing visual inertial odometry on the image data to provide camera quaternions;
transferring the camera quaternions to second gravity coordinates; and
integrating the first gravity coordinates, the second gravity coordinates and variations in the IMU quaternions to provide the aligned quaternion coordinates.

5. The method of claim 4, wherein the compensating for the centrifugal force with respect to the angular velocity in the gyroscope data and the radius in the image data comprises:
obtaining translation data on an amount of translational movement based on the visual inertial odometry; and
compensating for the centrifugal force using the accelerometer data, the aligned quaternion coordinates, and the translation data to provide a compensated output.

6. The method of claim 5, further comprising:
transferring the accelerometer data to visual odometry coordinates; and
performing a filtering process on the accelerometer data in the visual odometry coordinates, the compensated output, and the translation data to provide a translation output.

7. The method of claim 6, wherein the performing of the filtering process comprises performing the filtering process using an Extended Kalman filter (EKF).

8. The method of claim 1, wherein the sensor data comprises accelerometer data from an accelerometer of the IMU and gyroscope data from a gyroscope of the IMU, and wherein the performing of the fusion process on the sensor data and the image data comprises:
performing stillness detection based on the accelerometer data and the gyroscope data;
responsive to the stillness detection indicating a motion, performing operations comprising:
performing sensor prediction to provide a prediction result;
performing less-feature detection on the image data to provide a first fusion factor;
performing visual inertial odometry on the image data to provide a second fusion factor; and
performing camera measurement to provide an output using the prediction result, the image data, the first fusion factor, and the second fusion factor.

9. The method of claim 8, wherein the performing of the stillness detection comprises:
receiving additional image data from an additional camera;
performing depth detection using the image data and the additional image data to provide a depth detection result; and
performing the stillness detection based on the accelerometer data, the gyroscope data, and the depth detection result.

10. The method of claim 1, wherein the performing of the one or more 6 DoF-related operations using the translation output comprises:
receiving eye movement data from an eye detector;
performing behavior simulation using the eye movement data and the 6 DoF output to provide a simulated human behavior with a latency in movement; and
rendering virtual reality (VR) or augmented reality (AR) using the simulated human behavior.

11. An apparatus, comprising:
an image sensor capable of capturing images to provide image data;
an inertial measurement unit (IMU) capable of measuring motion-related parameters to provide sensor data; and
a processor communicatively coupled to the image sensor and the IMU, the processor capable of:
receiving the sensor data from the IMU;
receiving the image data from the image sensor;
performing a fusion process on the sensor data and the image data to provide a translation output; and
performing one or more six-degrees-of-freedom (6 DoF)-related operations using the translation output.

12. The apparatus of claim 11, wherein, in performing the fusion process on the sensor data and the image data, the processor fuses the sensor data and the image data to generate a result with scale, and wherein the result has a latency lower than a threshold latency and a report rate higher than a threshold report rate.

13. The apparatus of claim 11, wherein the sensor data comprises accelerometer data from an accelerometer of the IMU and gyroscope data from a gyroscope of the IMU, and wherein, in performing the fusion process on the sensor data and the image data, the processor performs operations comprising:
calculating a scale of a movement based on double integration of the accelerometer data;
obtaining aligned quaternion coordinates; and
compensating for a centrifugal force with respect to an angular velocity in the gyroscope data and a radius in the image data.

14. The apparatus of claim 13, wherein, in obtaining the aligned quaternion coordinates, the processor performs operations comprising:
integrating the gyroscope data and the accelerometer data to provide IMU quaternions;
transferring the IMU quaternions to first gravity coordinates;
performing visual inertial odometry on the image data to provide camera quaternions;
transferring the camera quaternions to second gravity coordinates; and
integrating the first gravity coordinates, the second gravity coordinates and variations in the IMU quaternions to provide the aligned quaternion coordinates.

15. The apparatus of claim 14, wherein, in compensating for the centrifugal force with respect to the angular velocity in the gyroscope data and the radius in the image data, the processor performs operations comprising:
obtaining translation data on an amount of translational movement based on the visual inertial odometry; and
compensating for the centrifugal force using the accelerometer data, the aligned quaternion coordinates, and the translation data to provide a compensated output.

16. The apparatus of claim 15, the processor is further capable of performing operations comprising:
transferring the accelerometer data to visual odometry coordinates; and
performing a filtering process on the accelerometer data in the visual odometry coordinates, the compensated output, and the translation data to provide a translation output.

17. The apparatus of claim 16, wherein, in performing the filtering process, the processor performs the filtering process using an Extended Kalman filter (EKF).

18. The apparatus of claim 11, wherein the sensor data comprises accelerometer data from an accelerometer of the IMU and gyroscope data from a gyroscope of the IMU, and wherein, in performing the fusion process on the sensor data and the image data, the processor performs operations comprising:
performing stillness detection based on the accelerometer data and the gyroscope data;
responsive to the stillness detection indicating a motion, performing operations comprising:
performing sensor prediction to provide a prediction result;
performing less-feature detection on the image data to provide a first fusion factor;
performing visual inertial odometry on the image data to provide a second fusion factor; and
performing camera measurement to provide an output using the prediction result, the image data, the first fusion factor, and the second fusion factor.

19. The apparatus of claim 18, wherein, in performing the stillness detection, the processor performs operations comprising:
receiving additional image data from an additional camera;
performing depth detection using the image data and the additional image data to provide a depth detection result; and
performing the stillness detection based on the accelerometer data, the gyroscope data, and the depth detection result.

20. The apparatus of claim 11, wherein, in performing the one or more 6 DoF-related operations using the translation output, the processor performs operations comprising:
receiving eye movement data from an eye detector;
performing behavior simulation using the eye movement data and the 6 DoF output to provide a simulated human behavior with a latency in movement; and
rendering virtual reality (VR) or augmented reality (AR) using the simulated human behavior.
